(19) United States
(12) Patent Application Publication
(10) Pub. No.: US 2006/0084566 A1
(43) Pub. Date: Apr. 20, 2006

(54) Multiphase ceramic nanocomposites and method of making them

(75) Inventors: Julin Wan, Rexford, NY (US); Sergio Paulo Martins Loureiro, Saratoga Springs, NY (US); Mohan Manoharan, Niskayuna, NY (US); Reza Sarrafi-Nour, Clifton Park, NY (US); Seth Thomas Taylor, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/968,742

(22) Filed: Oct. 19, 2004

(51) Int. Cl. C04B 35/571; C04B 35/5835; C04B 35/589; C03B 19/09; C04B 35/64

(52) U.S. Cl. 501/96.2; 501/92; 501/96.4; 65/33.1; 65/17.3; 264/604

(57) ABSTRACT

Multiphase ceramic nanocomposites having at least three phases are disclosed. Each of the at least three phases has an average grain size less than about 100 nm. In one embodiment, the ceramic nanocomposite is substantially free of glassy grain boundary phases. In another embodiment, the multiphase ceramic nanocomposite is thermally stable up to a temperature of at least about 1500° C. Methods of making such multiphase ceramic nanocomposites are also disclosed.

### BACKGROUND OF THE INVENTION

The invention relates to ceramic nanocomposites. More particularly, the invention relates to multiphase ceramic nanocomposites that are substantially free of glassy grain boundaries or are thermally stable at high temperatures. The invention also relates to a method of making such multiphase ceramic nanocomposites.

Ceramic nanocomposites have attracted attention in recent years due to their postulated room temperature properties such as hardness, strength and wear resistance, along with the possibility of enhanced superplasticity. Ceramic nanocomposites may be useful in a variety of structural applications, such as, for example, turbine assemblies for power generation and aircraft propulsion.

Although there are currently two reported methods to produce multiphase nanocrystalline ceramics, the methods tend to form grain sizes larger than 100 nm, sometimes even in the micrometer range. In fact, the multiphase nanocrystalline ceramics are sometimes inaccurately designated as nanocomposites because their microstructure are actually a hybrid of micro-and-nano phases.

Therefore, a need still exists for a multiphase ceramic nanocomposite that is thermally stable wherein each phase has an average grain size of less than about 100 nm. What is also needed is a multiphase ceramic nanocomposite that is substantially free of glassy grain boundary phases. What is also needed is a method of making such multiphase ceramic nanocomposites.

### SUMMARY OF THE INVENTION

The invention meets these and other needs by providing a multiphase ceramic nanocomposite comprising at least three phases. A method of making such a nanocomposite is also disclosed.

Accordingly, an aspect of the invention is to provide a multiphase ceramic nanocomposite comprising at least three phases. Each of the at least three phases has an average grain size less than 100 nm. The multiphase ceramic nanocomposite is substantially free of glassy grain boundary phases.

Another aspect of the invention is to provide a multiphase ceramic nanocomposite comprising at least three phases. Each of the at least three phases has an average grain size less than 100 nm. The multiphase ceramic nanocomposite is thermally stable up to a temperature of at least about 1500° C.

Yet another aspect of the invention is to provide a method of making a multiphase ceramic nanocomposite comprising at least three phases. Each of the at least three phases has an average grain size less than 100 nm and the multiphase ceramic nanocomposite is substantially free of glassy grain boundary phases. The method comprises the steps of: i) providing at least one amorphous ceramic powder substantially free of oxides; and ii) crystallizing and densifying the at least one amorphous ceramic powder to form the multiphase ceramic nanocomposite.

Another aspect of the invention is to provide a method of making a multiphase ceramic nanocomposite comprising at least three phases. Each of the at least three phases has an average grain size less than 100 nm and the multiphase ceramic nanocomposite is thermally stable up to a temperature of at least about 1500° C. The method comprises the steps of: i) providing at least one amorphous ceramic powder substantially free of oxides; and ii) crystallizing and densifying the at least one amorphous ceramic powder to form the multiphase ceramic nanocomposite.

These and other aspects, advantages, and salient features of the invention will become apparent from the following detailed description, the accompanying drawings, and the appended claims.

### BRIEF DESCRIPTION OF THE DRAWINGS

FIG. 1 is schematic representation of a known Si₃N₄/SiC hybrid micro-nanocomposite ceramic material having glassy grain boundaries;

FIG. 2 is a schematic representation of a Si₃N₄/SiC/BN multiphase ceramic nanocomposite of an embodiment of the invention that is substantially free of glassy grain boundaries;

FIG. 3 is an x-ray diffraction pattern of a Si₃N₄/SiC/BN multiphase ceramic nanocomposite of an embodiment of the invention showing the presence of multiple phases;

FIG. 4A is a bright field transmission electron microscope (TEM) image of a Si₃N₄/SiC/BN multiphase ceramic nanocomposite of an embodiment of the invention;

FIG. 4B is a dark field TEM image of the Si₃N₄/SiC/BN multiphase ceramic nanocomposite of an embodiment of the invention;

FIG. 5 is a high-resolution transmission electron microscope (HRTEM) image of a Si₃N₄/SiC/BN multiphase ceramic nanocomposite of an embodiment of the invention showing a grain boundary free of glassy grain boundary phases;

FIG. 6 is a HRTEM image of a multiphase ceramic nanocomposite of an embodiment of the invention showing grain boundaries that are free of glassy grain boundary phases between crystalline what phases and a boron nitride phase which are free of glassy grain boundary phases;

FIG. 7 is a HRTEM image of a Si₃N₄/SiC/BN multiphase ceramic nanocomposite of an embodiment of the invention showing a grain boundary triple junction that is substantially free of glassy grain boundary phases;

FIG. 8 is a TEM image showing the structure of a Si₃N₄/SiC/BN multiphase ceramic nanocomposite of an embodiment of the invention after exposure in nitrogen at 1600° C. for 100 hour;

FIG. 9 is a flow chart of a method for making a multi-phase ceramic nanocomposite of an embodiment of the invention;

FIG. 10 are Fourier Transform Infrared (FTIR) spectra showing the effect of doping level on a polymeric precursor;

FIG. 11 are FTIR spectra of a pyrolyzed polymeric precursor that is doped; and

FIG. 12 is an x-ray diffraction pattern of an amorphous ceramic powder produced by pyrolysis of a polymeric precursor.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Whenever a particular aspect of the invention is said to comprise or consist of at least one of elements of a group and combinations thereof, it is understood that the aspect may comprise or consist of any of the elements of the group, either individually or in combination with any of the other elements of that group.

Referring to the drawings in general, it will be understood that the illustrations are for the purpose of describing a particular embodiment of the invention and are not intended to limit the invention thereto.

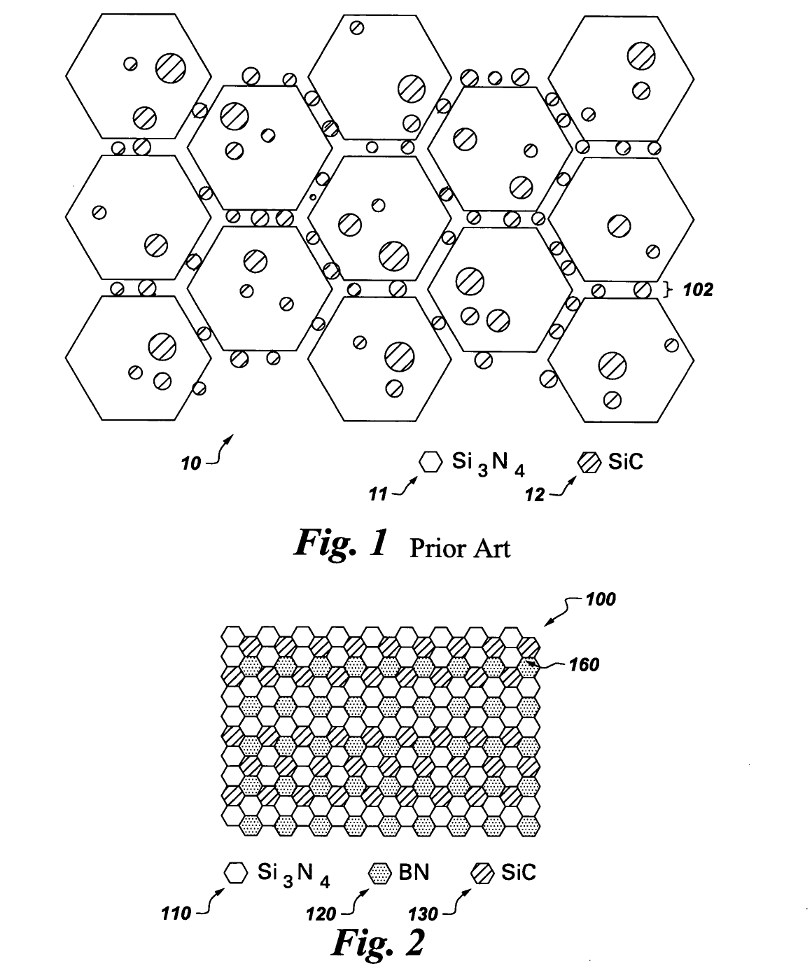

As a comparison, FIG. 1 is a schematic representation of a known Si₃N₄/SiC hybrid micro-nanocomposite 10 ceramic material with micro and nano phases. This type of hybrid micro-nanocomposite is composed of a micron-size matrix, with nano-sized inclusions within the grains and/or grain boundary regions. The hybrid micro-nanocomposite has glassy grain boundary phases 102 between two phases 11, 12. The glassy grain boundary phases 102 comprise oxides which is a result of the reaction between the silica oxide surface layers of the starting powder and the oxide additives used for processing this type of composites. Glassy grain boundary phases 102 may have a detrimental effect by adversely affecting high temperature properties, such as creep resistance, and promoting grain growth.

A ceramic nanocomposite of an embodiment of the invention is shown in FIG. 2. FIG. 2 is a schematic representation of a multiphase ceramic nanocomposite 100. The multiphase ceramic nanocomposite 100 comprises at least three phases, 110, 120, 130. Each of the at least three phases 110, 120, 130 has an average grain size less than about 100 nm. The multiphase ceramic nanocomposite 100 is substantially free of glassy grain boundary phases 102.

In one embodiment, the at least three phases 110, 120, 130 include, but are not limited to, at least one of a carbide, a nitride, a boride, and combinations thereof. Each of the three phases may individually comprise a carbide, a nitride, a boride or any combination thereof. In another embodiment, the three phases 110, 120, and 130, include, but are not limited to, at least one of silicon carbide, silicon nitride, boron nitride, boron carbide, zirconium carbide, zirconium nitride, hafnium carbide, hafnium boride, hafnium nitride, titanium carbide, titanium boride, titanium nitride, and combinations thereof. Each of the three phases may individually comprise any one of the above-referenced materials or in any combination therof.

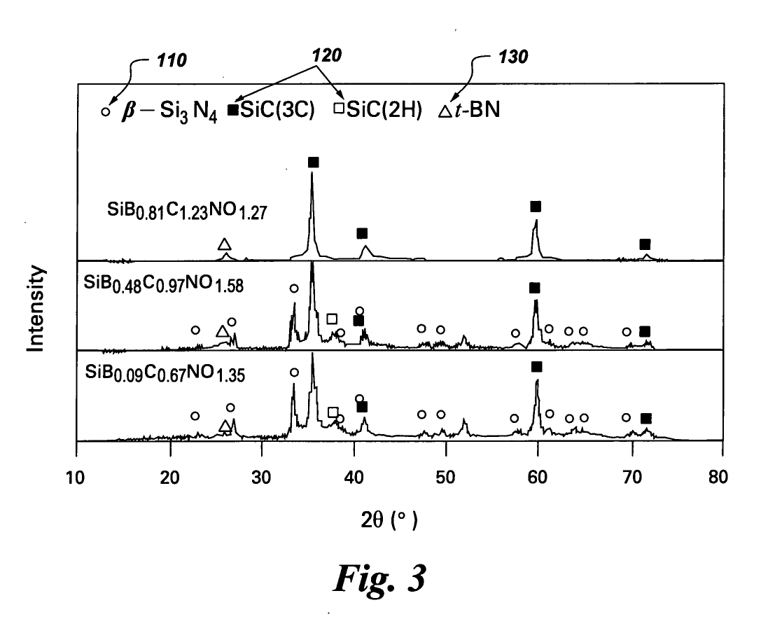

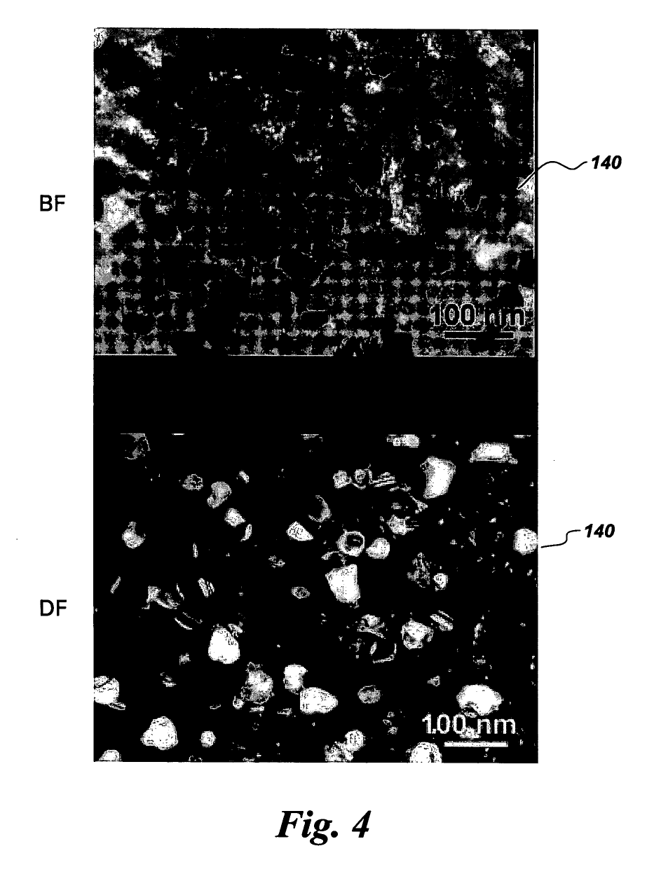

In one non-limiting example, the at least three phases include silicon carbide (SiC), silicon nitride (Si₃N₄), and boron nitride (BN). FIG. 2 is a schematic representation of such a Si₃N₄/SiC/BN multiphase ceramic nanocomposite 100. FIG. 3 is an x-ray diffraction pattern of a Si₃N₄/SiC/BN multiphase ceramic nanocomposite 100 of an embodiment of the invention showing the presence of three distinct phases.

Each of the at least three phases has an average grain size less than about 100 nm. FIG. 4A is a bright field transmission electron microscope (TEM) image of a Si₃N₄/SiC/BN multiphase ceramic nanocomposite 100 of one embodiment of the invention. The average grain size 140 of each phase shown in FIG. 4A is less than about 100 nm. FIG. 4B is a dark field TEM image of a multiphase ceramic nanocomposite 100 showing that the average grain size 140 of each phase is less than about 100 nm. In most cases, the average grain size is between about 30 nm to about 70 nm.

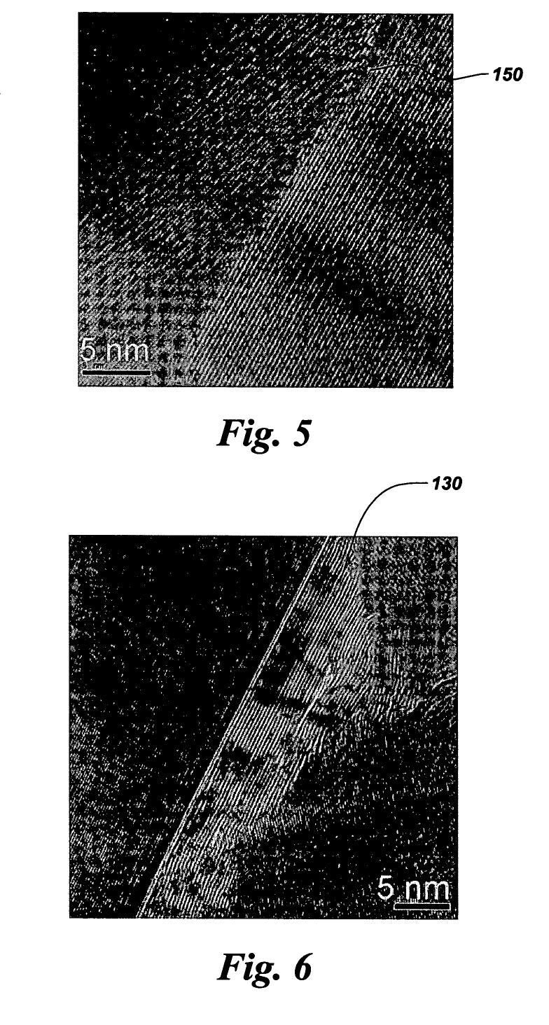

The multiphase ceramic nanocomposite 100 is also substantially free of glassy grain boundary phases 102. FIG. 5 is a high-resolution transmission electron microscope (HRTEM) image of a Si₃N₄/SiC/BN multiphase ceramic nanocomposite 100 of one embodiment of the invention showing a grain boundary 150. The grain boundary 150 is free of glassy grain boundary phases 102.

FIG. 6 is a HRTEM image of a Si₃N₄/SiC/BN multiphase ceramic nanocomposite 100 of one embodiment of the invention showing the grain boundaries 150 between the crystalline phases and the boron nitride phase 130. Similar to FIG. 5, the grain boundaries 150 are free of glassy grain boundary phases 102.

FIG. 7 is a HRTEM image of a Si₃N₄/SiC/BN multiphase ceramic nanocomposite 100 of one embodiment of the invention showing a triple junction 160 formed by the intersection of three-grain boundaries 150. Glassy grain boundary phases phases 102, if any, are usually present at such triple junctions. FIG. 6, however, shows that the triple junctions in the multiphase ceramic nanocomposite 100 of one embodiment of the invention are substantially free of glassy grain boundary phases 102.

Another aspect of the invention is to provide a multiphase ceramic nanocomposite 100 comprising at least three phases. Each of the at least three phases has an average grain size less than 100 nm. The multiphase ceramic nanocomposite 100 is thermally stable up to a temperature of at least about 1500° C. Thermally stable means significant changes in microstructure, grain or phase size, and composition do not occur with extensive exposure to elevated temperature.

In one embodiment, the multiphase ceramic nanocomposite 100 is thermally stable at a temperature in a range from about 1500° C. to about 2000° C.

Each of the at least three phases of the multiphase ceramic nanocomposite 100 maintained an average grain size below 100 nm according to the temperature and time as described, but not limited to, the conditions listed in Table 1.

TABLE 1
Thermal stability test of multiphase ceramic nanocomposite 100
wherein each phase retained an average grain size below 100 nm.

| Temperature (° C.) | Time (hours) |
|---|---|
| 1400 | 1000 |
| 1600 | 100 |
| 1900 | 4 |

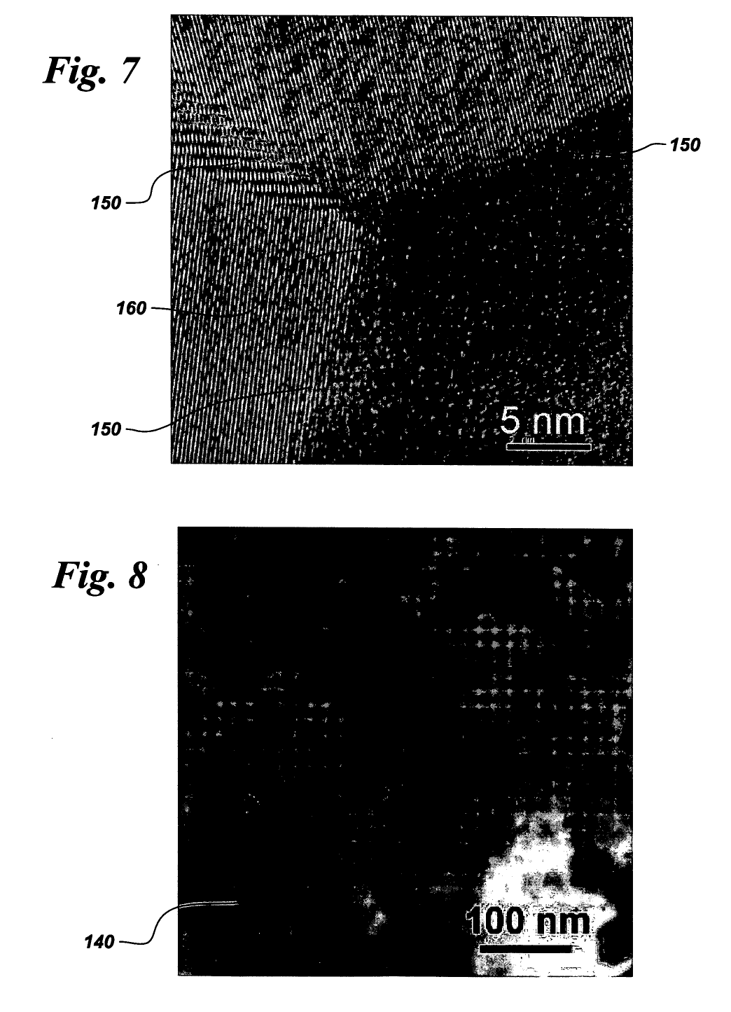

An example of the thermal stability of the multiphase ceramic nanocomposite 100 after long-term exposure is shown in FIG. 8. FIG. 8 is a TEM image showing the structure of a Si₃N₄/SiC/BN multiphase ceramic nanocomposite 100 after exposure in nitrogen at 1600° C. for 100 hour. Each phase retained an average grain size 140 less than 100 nm.

The thermal stability of the multiphase ceramic nanocomposite 100 is an indication of low material diffusivity in the multiphase ceramic nanocomposite. The low diffusivity, in turn, indicates that the multiphase ceramic nanocomposites 100 have the potential for high creep resistance, which i indicates high temperature related properties.

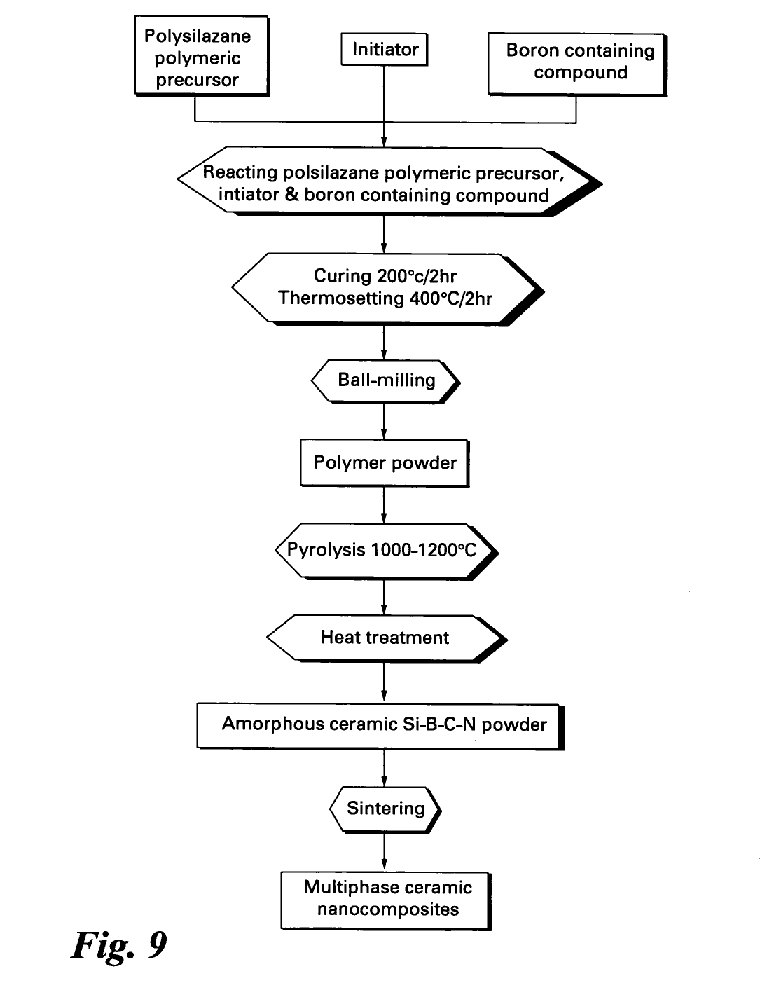

The invention also includes a method of making the multiphase ceramic nanocomposite 100 described hereinabove. The method comprises the steps of: providing at least one amorphous ceramic powder that is substantially free of oxides; and crystallizing and densifying the at least one amorphous ceramic powder to form the multiphase ceramic nanocomposite. FIG. 9 is a flow chart of one method of making such multi-phase ceramic nanocomposite.

First, the at least one amorphous ceramic powder that is substantially free of oxides is provided. In one embodiment, the amorphous power includes, but is not limited to, Si, B, C and N. In one embodiment, the step of providing the amorphous ceramic powder involves: providing at least one polymeric precursor; curing the at least one polymeric precursor; and pyrolyzing the cured at least one polymeric precursor to form the at least one amorphous ceramic powder. The candidate polymeric precursors include, but are not limited to, polysilanes, polysilazanes, polycarbosilanes, polyborosilazanes, polyborazylenes, and combinations thereof. The polymeric precursor may comprise polysilane, polysilazane, polycarbosilane, polyborosilazane, polyborazylenes, either individually or in any combinations with each other. Optionally, the polymeric precursor may be reacted with at least one organometallic dopant. The organometallic dopant provides material for the phases. In one embodiment, the organo-metallic dopant includes, but is not limited to, at least one of an organo-boron, an organo-zirconium, an organo-titanium, an organo-hafnium, an organo-yttrium, a organo-magnesium, an organo-aluminum and combinations thereof. In another embodiment, the at least one organometallic dopant includes, but is not limited to, at least one of hydrides, alkyl derivatives, alkoxyl derivatives, aralkyl derivatives, alkylynyl derivatives, aryl derivatives, cyclopentadienyl derivatives, arene derivatives, olefin complexes, acetylene complexes, isocyanide complexes, and combinations thereof.

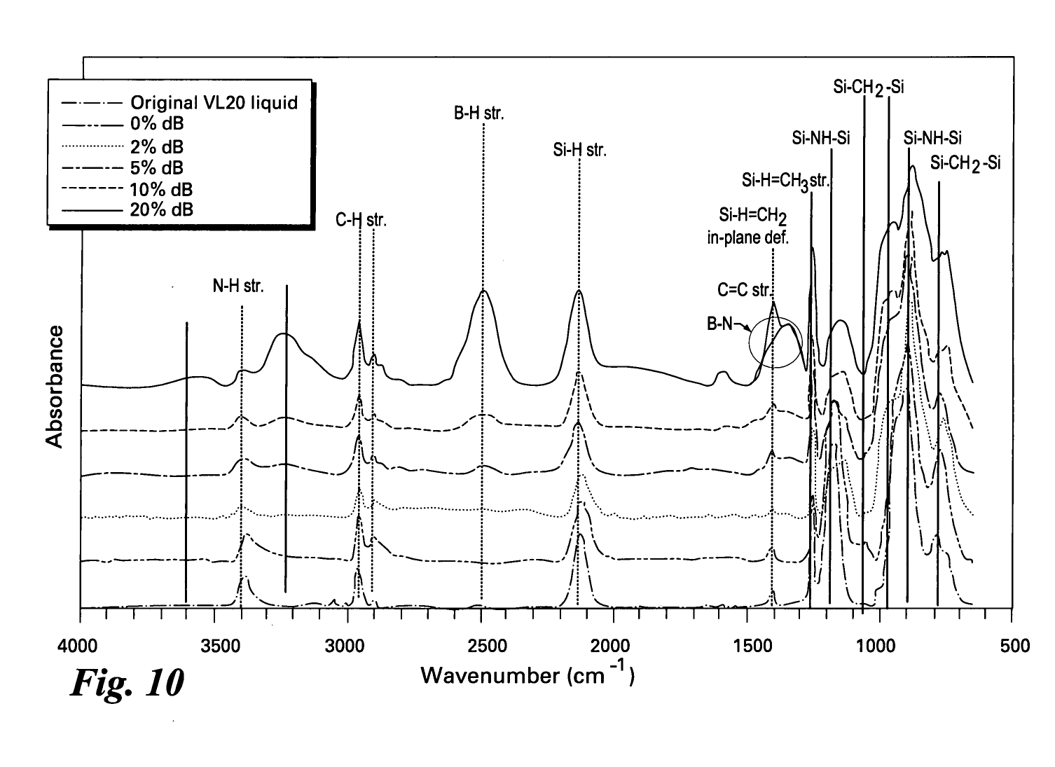

For example, the at least one polymeric precursor can be a commercially available polysilazane or polycarbosilane. Optionally, the polymeric precursor may be reacted with the organometallic dopant, such as a boron-containing agent. The boron-containing agent can be a borane, a borazine, or a polyborazine. The boron-containing agent within the resultant doped polymeric precursor can be 0-40% by weight of the polymeric precursor. FIG. 10 are Fourier Transform Infrared (FTIR) spectra showing the effect of doping level on a polymeric precursor, a band corresponding to B—N vibration develops with the increase of doping, which shows incorporation of B into the precursor network by dehydrogenation.

The polymeric precursor is then cured. Curing can be performed with the assistance of a radical-generating initiator, such as, but not limited to, an organic peroxide. The organic peroxide may be 0-5% of the weight of the ceramic precursor.

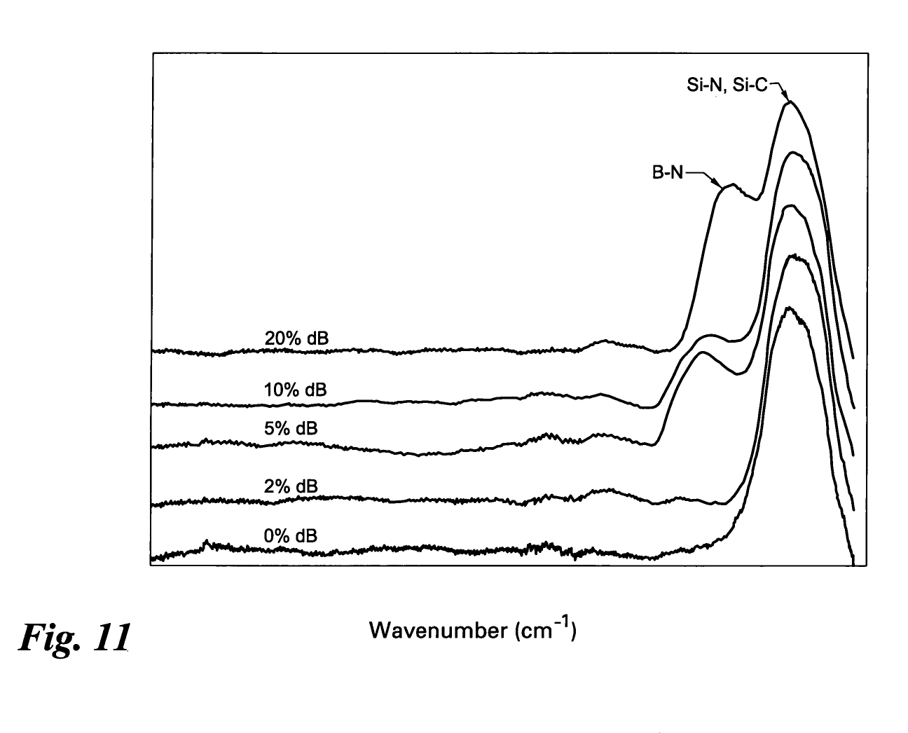

After providing and curing the at least one polymeric precursor, the at least one polymeric precursor may then be pyrolyzed to form the at least one amorphous ceramic powder. Optionally, the polymeric precursor may be pyrolyzed in a reactive atmosphere or in an inert atmosphere. For example, the polymeric precursor may be pyrolyzed in an atmosphere comprising argon, nitrogen, or ammonia at a temperature ranging from about 900° C. to about 1200° C. to form the amorphous ceramic powder. FIG. 11 is an FTIR spectra of the pyrolyzed amorphous ceramic powder, showing the vibrations corresponding to Si—C, Si—N, and in the B doped powders, the vibrations of B—N. The B-doped precursor is converted into a ceramic composed of Si—B—C—N.

An advantage of one embodiment of the invention is that boron introduction also leads to the increase of polymer-to-ceramic conversion rate, from around 70-75% towards around 90% by weight.

Optionally, the at least one amorphous ceramic powder that is formed may be heat-treated. In one embodiment, the at least one amorphous ceramic powder may be heat treated at a temperature above the final pyrolysis temperature, but below the onset temperature for crystallization, such as in a range from about 1200° C. to about 1500° C.

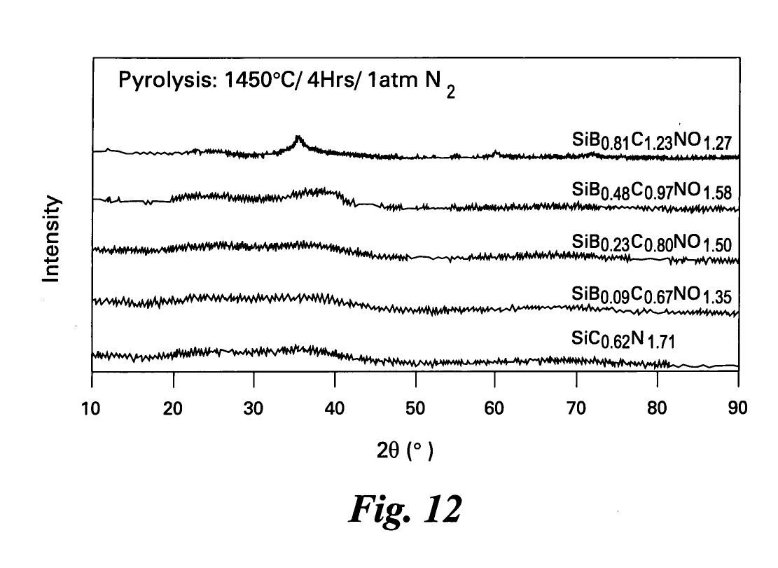

The pyrolyzed polymeric precursor can retain amorphous structure up to the temperatures at which the nucleation process for subsequent crystallization is complete. FIG. 12 is an x-ray diffraction pattern of an amorphous ceramic powder formed by pyrolyzing the at least one polymeric precursor, showing the amorphous nature of the ceramic powder. The amorphous ceramic powder may optionally be milled to adjust the particle size of the amorphous ceramic powder from about 0.5 μm to about 40 μm. In another embodiment, the particle size may be from about 0.5 μm to about 10 μm.

After providing the at least one amorphous ceramic powder, the second step in the method of making the multiphase ceramic composite includes crystallizing and densifying the amorphous ceramic power to form the multiphase ceramic composite. In one embodiment, the step of crystallizing and densifying the at least one amorphous ceramic powder comprises sintering, such as, but not limited to, spark plasma sintering, hot isostatic pressing, and combinations therof.

As an example, sintering of the amormphous ceramic powder was done by spark plasma sintering (SPS). The powder was loaded into a graphite die and pre-pressed at about 20 MPa pressure before installed in a SPS System. The SPS system sends a pulsing electric field directly through the die and punch assembly, which enables fast heating of the specimen. Moreover, the pulsing electric field also serves to generate an activation effect, which is an acceleration of surface diffusion. The activation effect accelerates the densification process, which in turn leads to more effective sintering than conventional hot pressing. In one embodiment, the sintering is free of oxide-sintering aids.

Control parameters for spark plasma sintering of the amorphous ceramic powder are shown in Table 2.

TABLE 2
Control parameters for spark plasma sintering

| Parameter | Range | Preferred range |
|---|---|---|
| Sintering temperature(° C.) | 1600-2050 | 1700-1900 |
| Sintering time(min) | 5-120 | 10-30 |
| Heating rate(° C./min) | 50-500 | 100-250 |
| Pressure(MPa) | 20-200 | 50-100 |

The above-mentioned sintering process was conducted either in vacuum or in nitrogen atmosphere.

The amorphous Si—B—C—N network of the powder undergoes in-situ crystallization during sintering. The resultant material comprises Si₃N₄/SiC/BN as major phases as revealed by XRD, as shown in FIG. 2.

Densifying includes techniques such as, but not limited to, a combination of SPS and hot-isostatic pressing (HIP), or the use of hot-isostatic pressing alone. In the former case, a spark plasma sintered sample is supplied for HIP at higher temperatures, while in the latter case a powder compact is encapsulated and directly submitted for HIP at a temperature between about such as 1850° C. to about 2050° C.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the invention.

What is claimed is:

1. A multiphase ceramic nanocomposite comprising:
at least three phases, wherein each of the at least three phases has an average grain size less than about 100 nm; and
wherein the multiphase ceramic nanocomposite is substantially free of glassy grain boundary phases.

2. The multiphase ceramic nanocomposite of claim 1, wherein the at least three phases comprise at least one of a carbide, a nitride, a boride, and combinations thereof.

3. The multiphase ceramic nanocomposite of claim 2, wherein the at least three phases comprise at least one of silicon carbide, silicon nitride, boron nitride, boron carbide, zirconium carbide, zirconium nitride, hafnium carbide, hafnium boride, hafnium nitride, titanium carbide, titanium boride, titanium nitride, and combinations thereof.

4. The multiphase ceramic nanocomposite of claim 3, wherein the at least three phases comprise silicon carbide, silicon nitride, and boron nitride.

5. A multiphase ceramic nanocomposite comprising:
at least three phases, wherein each of the at least three phases has an average grain size less of than about 100 nm; and
wherein the multiphase ceramic nanocomposite is thermally stable up to a temperature of at least about 1500° C.

6. The multiphase ceramic nanocomposite of claim 5, wherein the at least three phases comprise at least one of a carbide, a nitride, a boride, and combinations thereof.

7. The multiphase ceramic nanocomposite of claim 6, wherein the at least three phases comprise at least one of silicon carbide, silicon nitride, boron nitride, boron carbide, zirconium carbide, zirconium nitride, hafnium carbide, hafnium boride, hafnium nitride, titanium carbide, titanium boride, titanium nitride, and combinations thereof.

8. The multiphase ceramic nanocomposite of claim 7, wherein the at least three phases comprise silicon carbide, silicon nitride, and boron nitride.

9. The multiphase ceramic nanocomposite of claim 5, wherein the multiphase ceramic nanocomposite is substantially free of glassy grain boundary phases.

10. The multiphase ceramic nanocomposite of claim 5, wherein the multiphase ceramic nanocomposite is thermally stable up to a temperature in a range from about 1500° C. to about 2000° C.

11. A method of making a multiphase ceramic nanocomposite comprising at least three phases, wherein each of the at least three phases has an average grain size less than about 100 nm; and wherein the multiphase ceramic nanocomposite is substantially free of glassy grain boundary phases, the method comprising the steps of:
a) providing at least one amorphous ceramic powder, wherein the at least one amorphous ceramic powder is substantially free of oxides; and
b) crystallizing and densifying the at least one amorphous ceramic powder to form the multiphase ceramic nanocomposite.

12. The method of claim 11, wherein the at least three phases comprise at least one of a carbide, a nitride, a boride, and combinations thereof.

13. The method of claim 12, wherein the at least three phases comprise at least one of silicon carbide, silicon nitride, boron nitride, boron carbide, zirconium carbide, zirconium nitride, hafnium carbide, hafnium boride, hafnium nitride, titanium carbide, titanium boride, titanium nitride, and combinations thereof.

14. The method of claim 13, wherein the at least three phases comprise silicon carbide, silicon nitride, and boron nitride.

15. The method of claim 11, wherein the step of crystallizing and densifying the at least one amorphous ceramic powder comprises sintering the at least one amorphous ceramic powder.

16. The method of claim 15, wherein the step of sintering the at least one amorphous ceramic powder comprises at least one of spark plasma sintering the at least one amorphous ceramic powder comprises, hot isostatic the at least one amorphous ceramic powder comprises, and combinations thereof.

17. The method of claim 15, wherein the step of sintering is free of oxide sintering aids.

18. The method of claim 11, wherein the step of providing the at least one amorphous ceramic powder comprises:
i) providing at least one polymeric precursor;
ii) curing the at least one polymeric precursor; and
iii) pyrolyzing the cured at least one polymeric precursor at a first temperature to form the at least one amorphous ceramic powder.

19. The method of claim 18, further comprising the step of heat-treating the formed at least one amorphous ceramic powder at a second temperature, wherein the second temperature is greater than the first temperature.

20. The method of claim 18, further comprising the step of reacting the at least one polymeric precursor with at least one organometallic dopant.

21. The method of claim 20, wherein the at least one organometallic dopant comprises at least one of an organo-boron, an organo-zirconium, an organo-titanium, an organo-hafnium, an organo-yttrium, a organo-magnesium, an organo-aluminium and combinations thereof.

22. The method of claim 20, wherein the at least one organometallic dopant comprises of at least one of a hydride, an alkyl derivative, an alkoxyl derivative, an aralkyl derivative, an alkylynyl derivative, an aryl derivative, a cyclopentadienyl derivative, an arene derivative, an olefin complex, an acetylene complex, an isocyanide complex, and combinations thereof.

23. The method of claim 18, wherein the step of pyrolyzing the at least one polymeric precursor comprises pyrolyzing in a reactive atmosphere.

24. The method of claim 18, wherein the step of pyrolyzing the at least one polymeric precursor comprises pyrolyzing in an inert atmosphere.

25. The method of claim 18, wherein the at least one polymeric precursor comprises at least one of a polysilane, a polysilazane, a polycarbosilane, a polyborosilazane, a polyborazylene, and combinations thereof.

26. A method of making a multiphase ceramic nanocomposite comprising: at least three phases wherein each of the at least three phases has an average grain size less than about 100 nm; and wherein the multiphase ceramic nanocomposite is thermally stable up to a temperature of at least about 1500° C., the method comprising the steps of:
i) providing at least one amorphous ceramic powder, wherein the at least one amorphous ceramic powder is substantially free of oxides; and
ii) crystallizing and densifying the at least one amorphous ceramic powder to form the multiphase ceramic nanocomposite.

27. The method of claim 26, wherein the at least three phases comprise at least one of a carbide, a nitride, a boride, and combinations thereof.

28. The method of 27, wherein the at least three phases comprise at least one of silicon carbide, silicon nitride, boron nitride, boron carbide, zirconium carbide, zirconium nitride, hafnium carbide, hafnium boride, hafnium nitride, titanium carbide, titanium boride, titanium nitride, and combinations thereof.

29. The method of claim 28, wherein the at least three phases comprise silicon carbide, silicon nitride, and boron nitride.

30. The method of claim 26, wherein the multiphase ceramic nanocomposite is substantially free of glassy grain boundary phases.

31. The method of claim 26, wherein the multiphase ceramic nanocomposite is thermally stable up to a temperature in a range from about 1500° C. to about 2000° C.

32. The method of claim 26, wherein the step of crystallizing and densifying the at least one amorphous ceramic powder comprises sintering.

33. The method of claim 26, wherein the step of sintering the at least one amorphous ceramic powder comprises at least one of spark plasma sintering the at least one amorphous ceramic powder comprises, hot isostatic pressing the at least one amorphous ceramic powder comprises, and combinations thereof.

34. The method of claim 33, wherein the step of sintering is free of oxide sintering aids.

35. The method of claim 26, wherein the step of providing the at least one amorphous ceramic powder comprises:
i) providing at least one polymeric precursor;
ii) curing the at least one polymeric precursor; and
iii) pyrolyzing the cured at least one polymeric precursor at a first temperature to form the at least one amorphous ceramic powder.

36. The method of claim 35, further comprising heat-treating the at least one amorphous ceramic powder at a second temperature, wherein the second temperature is greater than the first temperature.

37. The method of claim 35, further comprising reacting the at least one polymeric precursor with at least one organometallic dopant.

38. The method of claim 37, wherein the at least one organometallic dopant comprises at least one of an organo-boron, an organo-zirconium, an organo-titanium, an organo-hafnium, an organo-yttrium, a organo-magnesium, an organo-aluminum and combinations thereof.

39. The method of claim 37, wherein the at least one organometallic dopant comprises of at least one of a hydride, an alkyl derivative, an alkoxyl derivative, an aralkyl derivative, an alkylynyl derivative, an aryl derivative, a cyclopentadienyl derivative, an arene derivative, an olefin complex, an acetylene complex, an isocyanide complex, and combinations thereof.

40. The method of claim 35, wherein the step of pyrolyzing the at least one polymeric precursor comprises pyrolyzing in a reactive atmosphere.

41. The method of claim 35, wherein the step of pyrolyzing the at least one polymeric precursor comprises pyrolyzing in an inert atmosphere.

42. The method of claim 35, wherein the at least one polymeric precursor comprises at least one of a polysilane, a polysilazane, a polycarbosilane, a polyborosilazane, a polyborazylene, and combinations thereof.
